(19) United States
(12) Patent Application Publication
(10) Pub. No.: US 2026/0276891 A1
(43) Pub. Date: Sep. 17, 2026

(54) PROTECTIVE ENCLOSURE FOR OPTICAL FIBER SPLICE

(71) Applicant: Clearfield, Inc., Minneapolis, MN (US)

(72) Inventors: John P. Hill, Oak Grove, MN (US); Donovan J. Hample, Otsego, MN (US); James Henschel, Chula Vista, CA (US); Jesse A. Columbus, River Falls, WI (US)

(21) Appl. No.: 19/081,471

(22) Filed: Mar. 17, 2025

(51) Int. Cl. G02B 6/255; G02B 6/44

(52) U.S. Cl. CPC G02B 6/2558; G02B 6/443

(57) ABSTRACT

A clamshell device for surrounding and protecting an optical fiber splice and the bare optical fiber going in and out of the splice. The clamshell device can include jacketing gripping features on each end to secure the clamshell to protective jacketing on either side of the splice. The clamshell may be assembled by mating two identical half pieces around the splice, with one of the half pieces rotated 180 degrees axially with respect to the optical fiber axis and 180 degrees radially about the optical fiber so that mating slots and tabs engage to form the clamshell. Once assembled around the splice, the entire clamshell may be over molded for further protection.

### FIELD OF THE INVENTION

The disclosed technology generally relates to the field of optical fiber splicing, and more particularly, to a protective two-piece enclosure device configured to enclose and protect an optical fiber splice and the associated optical fiber.

### BACKGROUND

Optical fiber splicing is a critical process commonly utilized in fiber optic communications in which two separate sections of optical fiber are joined at cleaved ends with cores of the two optical fibers aligned to ensure minimal signal loss. In the case of fusion splicing, the two ends of the optical fiber are fused together while the cores are aligned. In situations where a fusion splicing machine is not available or practical, a small mechanical splice may be used to align and hold prepared optical fiber ends together to provide mechanical integrity at the connection point between the joined ends. In some mechanical splices, an index matching gel can be utilized to reduce reflections at the core-air boundary at the splice point. In both the fusion splice and the mechanical splice, transmission losses can be reduced by maintaining precise alignment of the cores with each other while reducing refractive index mismatches at the splice point between the cores.

Whether a fusion splice or a mechanical splice is utilized, the optical fiber ends are typically prepared by first removing a few inches of outer jacketing and/or buffering from each end to be joined. Certain optical fiber can include a removable outer cladding material that can be stripped away to expose the inner cladding surrounding the core so that the ends can be cleaved to provide flat ends for joining. Even after performing a fusion splice and covering the spliced section with a protective sleeve, or joining two fibers with a mechanical splice, there is typically a section of unprotected optical fiber on either side of the splice that requires careful handling to avoid fiber breakage. Thus, spliced optical fibers require protection from mechanical stress and bending of the optical fibers, particularly in regions near the ends of a splice where sections of fiber are bare and/or unjacketed. In some applications, spliced optical fibers can require protection from environmental factors such as moisture. Existing protective solutions often lack sufficient strain relief, fail to provide a secure and reliable enclosure, and/or require an unoccupied slot in a splice tray or other protective housing.

A need exists for an improved optical fiber splice protective device that ensures robust protection in various environments.

### BRIEF SUMMARY

Certain implementations of the disclosed technology include an optical fiber splice protective device made from a first half piece and a second half piece. In certain implementations, each of the first half piece and the second half piece are characterized by an elongated member having a first end, a middle section comprising a partial splice holder, a first channel extending from the first end of the elongated member to the middle section and in communication with a first end of the partial splice holder, a second end, and a second channel extending from the second end of the elongated member to the middle section and in communication with a second end of the partial splice holder. The first half piece is configured to mate with the second half piece to form a splice holder around an optical fiber splice disposed in the middle section, and the first channel and the second channel are configured to protect optical fiber coming out of both ends of the optical fiber splice.

Certain implementations of the disclosed technology include an overmolded optical fiber splice protective device that includes a first half piece and an equivalent second half piece. Each of the first half piece and the second half piece include an elongated member defining a first end, a middle section comprising a partial splice holder, a first channel extending from the first end of the elongated member to the middle section and in communication with a first end of the partial splice holder, a second end, and a second channel extending from the second end of the elongated member to the middle section and in communication with a second end of the partial splice holder. The first half piece is configured to mate with the second half piece to form an assembled device, and an overmold material may surround the assembled device.

Certain implementations of the disclosed technology include a method of assembling an optical fiber splice protective device. The method includes placing an optical fiber splice in a partial splice holder of a first half piece; rotating a second half piece that is equivalent to the first half piece 180 degrees about a perpendicular axis, mating the second half piece with the first half piece to form an assembled device such that a partial splice holder of the second half piece aligns with the partial splice holder of the first half piece to secure the optical fiber splice therebetween, and applying an overmold material to encase the assembled device.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE DRAWINGS

Reference will now be made to the accompanying figures and flow diagrams, which are not necessarily drawn to scale.

FIG. 1 illustrates a perspective view of a first half piece of the optical fiber splice protective device, in accordance with certain exemplary implementations of the disclosed technology.

FIG. 2 illustrates a top-view of the first half piece of the optical fiber splice protective device, in accordance with certain exemplary implementations of the disclosed technology.

FIG. 3A illustrates a side-view of the first half piece of the optical fiber splice protective device, in accordance with certain exemplary implementations of the disclosed technology.

FIG. 3B illustrates a magnified side-view of a fiber jacketing gripping member disposed at a first end of the first half piece of the optical fiber splice protective device, as illustrated in FIG. 3A, in accordance with certain exemplary implementations of the disclosed technology.

FIG. 3C illustrates a magnified side-view of a fiber jacketing gripping features disposed at a second end of the first half piece of the optical fiber splice protective device, as illustrated in FIG. 3A, in accordance with certain exemplary implementations of the disclosed technology.

FIG. 3D illustrates a magnified top-view of a splice holder in a middle section of the first half piece of the optical fiber splice protective device, as illustrated in FIG. 3A, in accordance with certain exemplary implementations of the disclosed technology.

FIG. 4A illustrates a perspective view of a splice between two sections of optical fiber that may be protected by certain exemplary implementations of the disclosed technology.

FIG. 4B illustrates a perspective view of the splice and optical fiber (as shown in FIG. 4A) with the splice placed in the splice holder of the first half piece of the optical fiber splice protective device, and a rotated second half piece of the optical fiber splice protective device arranged for mating with the first half piece around the splice to form a protective enclosure for the splice and for protecting sections of the fiber on either side of the splice, in accordance with certain exemplary implementations of the disclosed technology.

FIG. 5 illustrates a perspective view of an overmold fixture for covering an assembled optical fiber splice protective device (see FIG. 4B) with an overmold material to further protect the splice and the optical fiber, in accordance with certain exemplary implementations of the disclosed technology.

FIG. 6 illustrates a finished assembled optical fiber splice protective device (see FIG. 4B) covered with the overmold material (see FIG. 5), in accordance with certain exemplary implementations of the disclosed technology.

FIG. 7 is a flow diagram of a method 700 in accordance with certain exemplary implementations of the disclosed technology.

Various features of the technology described herein will become more apparent to those skilled in the art from a study of the Detailed Description in conjunction with the drawings. Those skilled in the art will recognize that alternative embodiments may be employed without departing from the principles of the technology. Accordingly, although specific embodiments are shown in the drawings, the technology is amenable to various modifications.

### DETAILED DESCRIPTION

The disclosed technology includes an optical fiber splice protective device and methods of manufacturing that can protect a splice and/or associate optical fiber from excess bending or breakage and/or environmental factors.

The terminology used herein is for the purpose of describing particular implementations and is not intended to be limiting. Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

Like numbers refer to like elements throughout. In the figures, the thickness of certain lines, layers, components, elements or features may be exaggerated for clarity.

It will be understood that when an element is referred to as being “on”, “attached” to, “connected” to, “coupled” with, “contacting”, “joined,” with etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

The disclosed technology includes an optical fiber splice protective device that can be assembled from two equivalent half pieces (i.e., a first half piece and a second half piece) that mate together to enclose and protect a splice and the optical fiber on both ends of the splice. The half pieces of the protective device can feature a fiber jacketing gripping member at a first end, a first channel extending from the gripping member to a middle section having partial splice holder, and a second channel extending from the splice holder to a second end. In certain implementations of the disclosed technology, the second end can include gripping features defined within the second channel such that jacketed fiber at either end of the splice can be secured between the fiber jacketing gripping member and the gripping features.

One aspect of the design of the protective device is its rotational asymmetry: when one half piece is rotated 180 degrees about an axis perpendicular to the optical fiber it can mate with the second half piece in a manner that aligns the gripping and securing features. When assembled, the device may form a splice holder channel around a splice in the middle portion and cylindrical channels for the optical fiber on either side of a splice, while fiber jacketing can be gripped at each end for strain relief. Further enhancements can include the optional overmolding to provide additional protection. In certain implementations, retaining and/or strain relief rings may secure the ends of the half pieces together and prevent overmolding material from escaping.

In certain implementations the half pieces can include overmold windows defined in a sidewall adjacent to the first and/or second channel to allow overmold material to enter the corresponding channels of the assembled device to further secure and protect the optical fiber at one or more ends of the optical fiber splice.

In accordance with certain exemplary implementations of the disclosed technology the half pieces can include tabs and notches that may mate and/or interlock with each other upon assembly to ensure secure mating with a corresponding half piece.

In certain implementations, the first half piece, when rotated 180 about a perpendicular axis, may align with the second half piece such that the fiber jacketing gripping member of a first half piece opposes the gripping features of the second half piece. In certain implementations of the disclosed technology, the partial splice holders of both half pieces may join to form a secure splice enclosure that can house and secure a splice.

In accordance with certain exemplary implementations of the disclosed technology, a splice and associated fiber may be protected by positioning the optical fiber splice in the partial splice holder of a first half piece and mating the second half piece by applying the required rotational alignment. Once assembled, the device may form an elongated central splice holder channel and cylindrical channels for the fiber on either side of the splice. The fiber jacketing gripping members can provide strain relief to prevent fiber movement.

In certain implementations, an overmold material may be formed around the protective device to further protect the splice and associated optical fiber from mechanical stress and/or environmental factors.

Additional implementations can include overmolding for enhanced protection. For example, overmold windows may be defined in each half piece to allow overmold material to enter the cylindrical fiber channels, securing the splice and unjacketed fiber sections. Crimp and/or strain relief rings may be added around the device's ends to secure the structure and contain overmolding material.

Particular details of the disclosed technology will now be described below with reference to the figures.

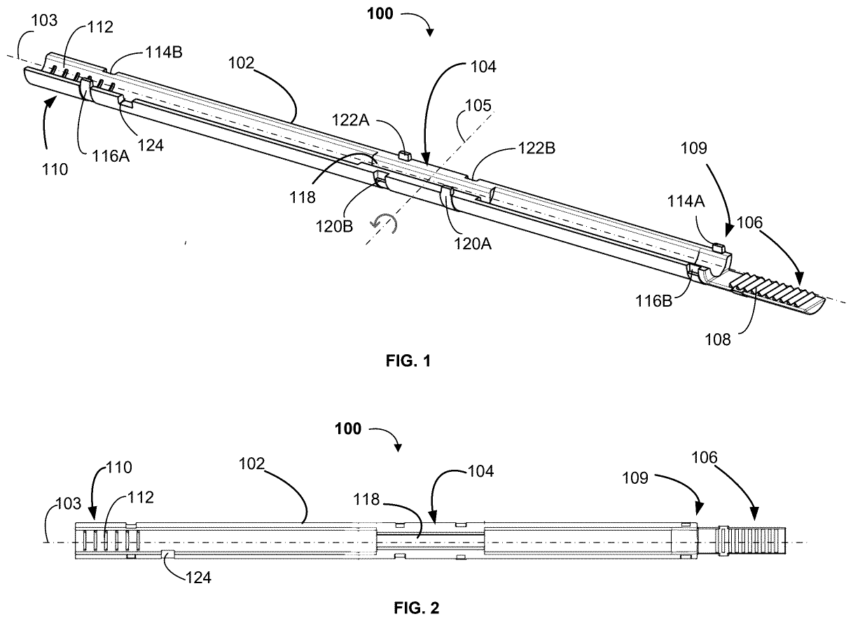

FIG. 1 illustrates a perspective view of a first half piece 100 of the optical fiber splice protective device, in accordance with certain exemplary implementations of the disclosed technology. Each half piece 100 includes an elongated member 102 with a corresponding longitudinal axis 103 and a perpendicular axis 105. In certain implementations, the optical fiber splice protective device can be assembled by rotating a second half piece 180 degrees about the perpendicular axis 105 and mating it with a (non-rotated) first half piece 100, as will be further discussed below.

In accordance with certain exemplary implementations of the disclosed technology, the half piece 100 can include a middle section 104 defining a partial splice holder 118 having a cutout region that can secure a splice therein. On either of the splice holder 118, the elongated member 102 can include cutout or half cylinder void regions extending to the respective ends 109 110 to allow room for optical fiber on either side of the splice holder 118 to be protected.

In accordance with certain exemplary implementations of the disclosed technology, one or more tabs 114A, 116A, 120A, 122A and notches 114B, 116B, 120B, 122B may be defined in each half piece 100 and configured to mate with corresponding notches and tabs of a respective second half piece when assembled.

As illustrated in FIG. 1, the half piece 100 can include a fiber jacketing gripping member 106 near the first end 109 and fiber jacketing gripping features 112 near the second end 110. When a second half piece 100 is rotated 180 degrees about the perpendicular axis 105 and mated with a (non-rotated) first half piece 100, jacketed fiber on either side of a splice may be secured between the fiber jacketing gripping member 106 of the first half piece 100 and the fiber jacketing gripping features 112 of a second half piece on both ends, for example, to provide optical fiber strain relief.

In accordance with certain exemplary implementations of the disclosed technology, the fiber jacketing gripping member 106 can include directional ridges 108 that may press jacketed optical fiber against corresponding gripping features 112 (of a second half piece 100) to secure jacketed optical fiber therebetween, while preferentially allowing jacketed optical fiber to “slide” towards the middle section 104 given an first force, while preventing the jacketed optical fiber to slide in the opposite directions under an opposite second force equal or more in magnitude to the first force. Thus, in certain implementations, the fiber jacketing gripping member 106 and directional ridges 108 may be configured to prevent excessive tensile tension on the optical fiber on either side of the splice.

With continued reference to FIG. 1, the half piece 100 can include one or more overmold windows 124 that may allow overmold material to enter and secure the optical fiber splice and/or associated optical fiber within the assembled device, as will be explained further below.

FIG. 2 illustrates a top-view of the first half piece 100 of the optical fiber splice protective device, in accordance with certain exemplary implementations of the disclosed technology, with like reference number as discussed above with reference to FIG. 1.

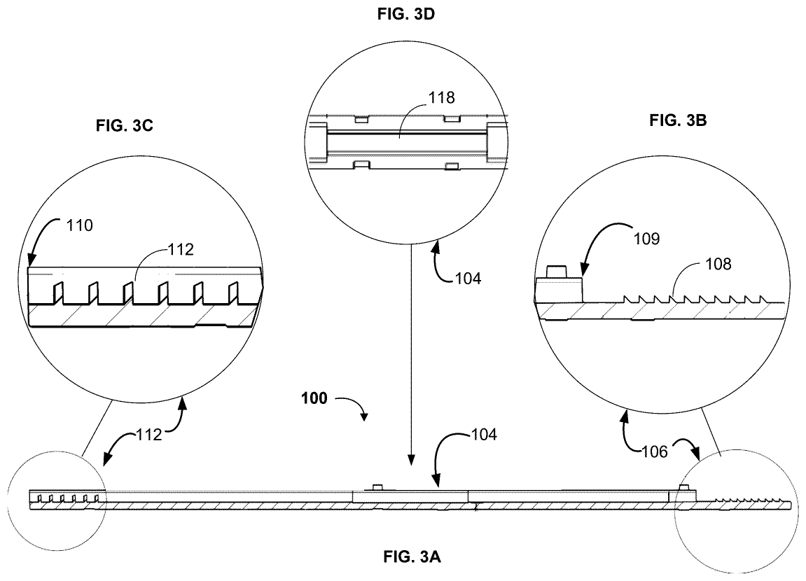

FIG. 3A illustrates a side-view of the first half piece 100 of the optical fiber splice protective device, showing the fiber jacketing gripping member 106, middle section 104, and gripping features 112, in accordance with certain exemplary implementations of the disclosed technology.

FIG. 3B illustrates a magnified side-view of a fiber jacketing gripping member 106 including the directional ridges 108 disposed at a first end 109 of the first half piece 100 of the optical fiber splice protective device, as illustrated in FIG. 3A, in accordance with certain exemplary implementations of the disclosed technology.

FIG. 3C illustrates a magnified side-view of fiber jacketing gripping features 112 disposed at a second end 110 of the first half piece 100 of the optical fiber splice protective device, as illustrated in FIG. 3A, in accordance with certain exemplary implementations of the disclosed technology.

FIG. 3D illustrates a magnified top-view of a splice holder 118 in a middle section 104 of the first half piece 100 of the optical fiber splice protective device, as illustrated in FIG. 3A, in accordance with certain exemplary implementations of the disclosed technology.

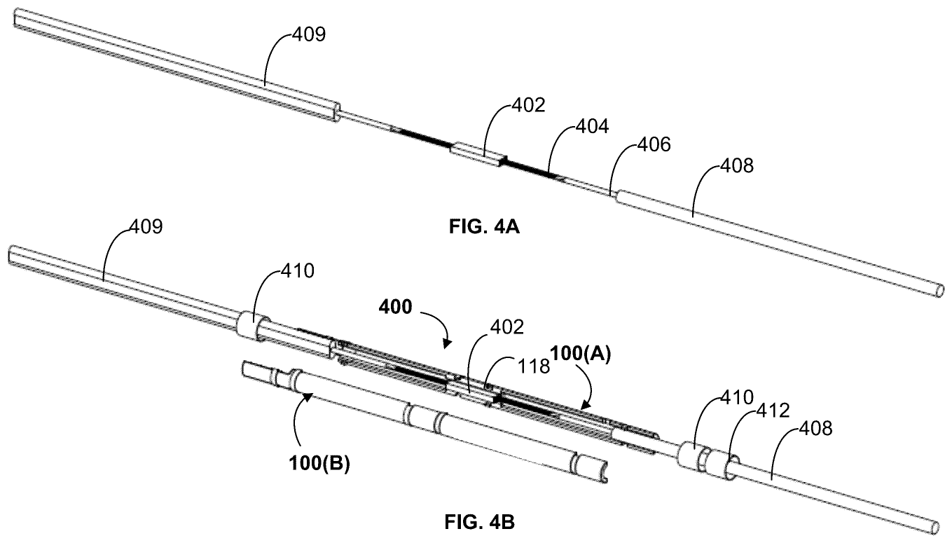

FIG. 4A illustrates a perspective view of an optical fiber splice 402 between two sections of bare optical fiber 404, buffered portions 406, and jacketed portions 408, 409 that may be protected by certain exemplary implementations of the disclosed technology. In certain implementations, the jacketed portion 408 on one side may have a different cross-sectional profile compared to the jacketed portion 409 on the other side of the splice.

FIG. 4B illustrates a perspective view of the splice 402 and optical fiber portions (as shown in FIG. 4A) with the splice 402 placed in the (partial) splice holder 118 of the first half piece 100(A) of the optical fiber splice protective device 400, and a rotated second half piece 100(B) of the optical fiber splice protective device 400 arranged for mating with the first half piece 100(A) around the splice 402 to form a protective enclosure for the splice 402 and for protecting the sections of the fiber 404, 406, 408, 409 on either side of the splice 402, in accordance with certain exemplary implementations of the disclosed technology.

In accordance with certain exemplary implementations of the disclosed technology, once the first half piece 100(A) of the optical fiber splice protective device 400 is mated with the rotated second half piece 100(B), one or more retaining rings 410 may be secured around one or more ends to the assembled optical fiber splice protective device 400 to further secure the first half piece 100(A) to the second half piece 100(B). In certain implementations, one or more strain relief rings 412 may be disposed partially around one or more ends of the device 400 and partially around the jacketed optical fiber 408, 409, for example, to aid in strain relief and to help limit bending of the fiber just beyond the ends of the assembled device 400.

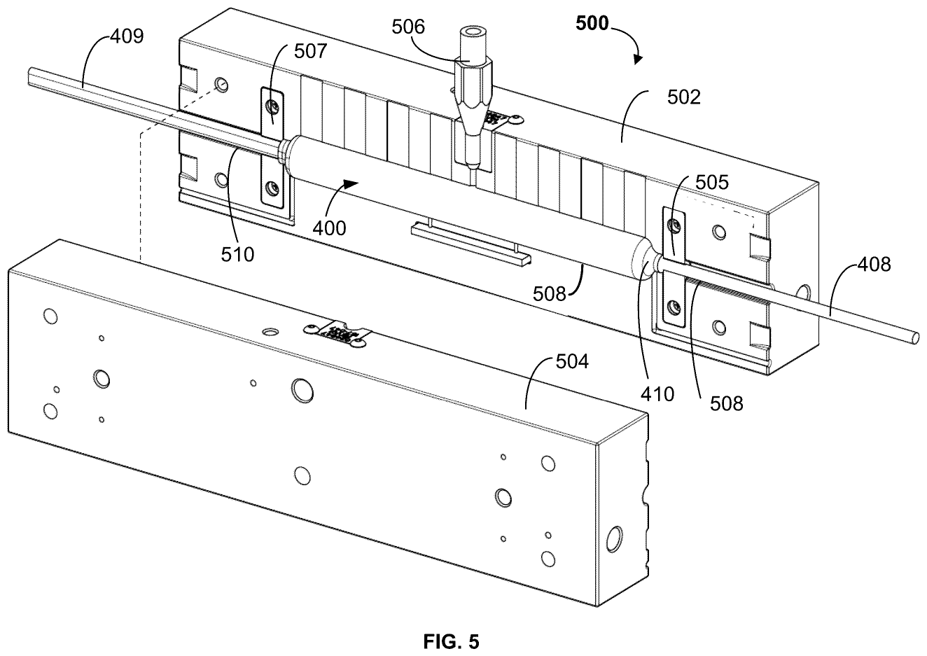

FIG. 5 illustrates an example perspective view of an overmold fixture 500 in which an assembled optical fiber splice protective device 400 (see FIG. 4B) may be inserted and covered with an overmold material 508 to further protect the splice and the optical fiber within the device 400.

In accordance with certain exemplary implementations of the disclosed technology, the overmold fixture 500 can be made from a main housing 502 and a removable cover 504. In certain implementations, an assembled optical fiber splice protective device 400 may be disposed in a void region in the main housing 502, with a portion 508 of the jacketed optical fiber 408 on one end secured by a clamping seal 505, while a portion 510 of jacketed optical fiber 409 on the other end secured by a corresponding clamping seal 507 at the other end. In accordance with certain exemplary implementations of the disclosed technology, the removable cover 504 may then be mated to the main housing 502 and overmold material may be fed into a port 506 to allow overmold material to fill the void around the entire optical fiber splice protective device 400 to produce an overmolded device 508. As discussed above, with reference to FIGS. 1 and 2, the half piece 100 can include one or more overmold windows 124 that may allow the overmold material to enter and secure the optical fiber splice and/or associated optical fiber within the assembled device.

As may be readily apparent to one of skill in the art, the clamping seals 505, 507 may help prevent overmold material from leaking out of the ends of the fixture 500 during the overmolding process. Once the overmold material has been cured, the cover 504 may be removed from the main housing 502 and the finished device 508 may be removed from the overmold fixture 500.

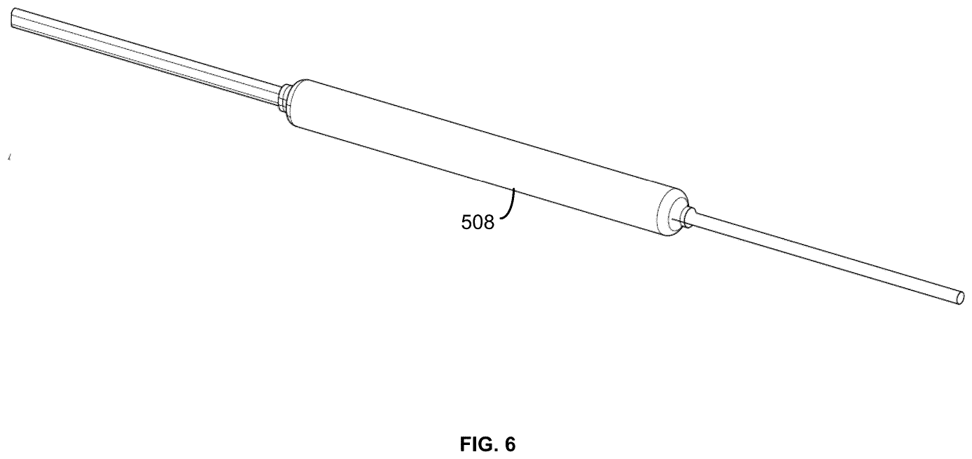

FIG. 6 illustrates a finished assembled optical fiber splice protective device 508 in (see FIG. 4B) covered with the overmold material (see FIG. 5), in accordance with certain exemplary implementations of the disclosed technology.

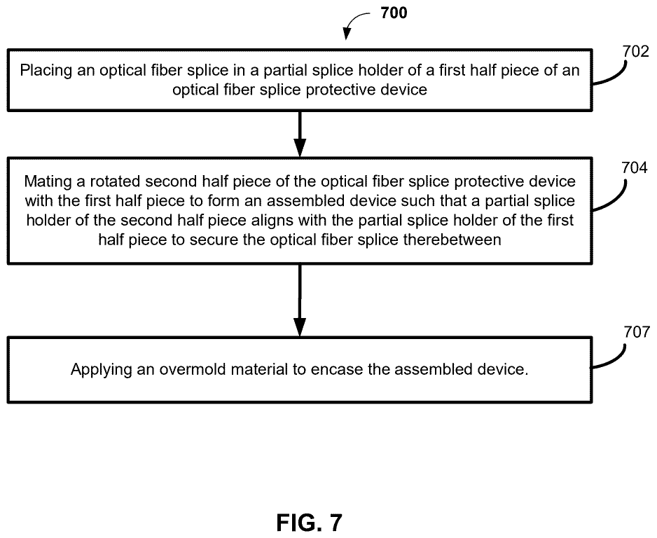

FIG. 7 is a flow diagram of a method 700 in accordance with certain exemplary implementations of the disclosed technology. In block 702, the method 700 can include placing an optical fiber splice in a partial splice holder of a first half piece of an optical fiber splice protective device. In block 704, the method 700 can include mating a rotated second half piece of the optical fiber splice protective device with the first half piece to form an assembled device such that a partial splice holder of the second half piece aligns with the partial splice holder of the first half piece to secure the optical fiber splice therebetween. In block 706, the method 700 can include applying an overmold material to encase the assembled device.

Certain implementations of the disclosed technology can include placing strain relief and/or retention rings around the ends of the device before applying the overmold.

In certain implementations, the first half piece and the second half piece can include a plurality of tabs and notches. Certain implementations of the disclosed technology can include mating corresponding tabs and notches of the first half piece with notches and tabs of the second half piece.

In accordance with certain exemplary implementations of the disclosed technology, the first half piece and the second half piece can each include a fiber jacketing gripping member in communication with a first end and a plurality of fiber jacketing gripping ridges defined in a gripping region adjacent to a second end. Certain implementations of the disclosed technology can include mating the first half piece to the second half piece so that the fiber jacketing gripping member and the plurality of fiber jacketing gripping ridges restrain jacketed optical fiber a the first end and the second end.

In the foregoing description, references to “an embodiment” or “certain embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims herein. Accordingly, the disclosure of various embodiments is intended to be illustrative, but not limiting, of the scope of the technology as set forth in the following claims.

What is claimed:

1. An optical fiber splice protective device comprising:
a first half piece and a second half piece, each comprising:
an elongated member, comprising:
a first end;
a middle section comprising a partial splice holder;
a first channel extending from the first end of the elongated member to the middle section and in communication with a first end of the partial splice holder;
a second end; and
a second channel extending from the second end of the elongated member to the middle section and in communication with a second end of the partial splice holder;
wherein the first half piece is configured to mate with the second half piece to form a splice holder around an optical fiber splice disposed in the middle section; and
wherein the first channel and the second channel are configured to protect optical fiber emanating from the optical fiber splice.

2. The device of claim 1, wherein the first half piece and the second half piece further comprise a plurality of tabs and notches configured to mate with corresponding notches and tabs of a respective second half piece and first half piece.

3. The device of claim 1, further comprising a fiber jacketing gripping member in communication with the first end of the elongated member.

4. The device of claim 1, further comprising fiber jacketing gripping features defined in a gripping region adjacent to the second end of the elongated member.

5. The device of claim 4, wherein the gripping region is defined on an interior wall of the second channel.

6. The device of claim 1, wherein the first half piece is rotationally asymmetrical such that when rotated 180 degrees about a perpendicular axis and mated with a second half piece forms:
the splice holder in the middle section;
cylindrical channels for protecting optical fiber on either side of the middle section;
optical fiber strain relief features adjacent to the first end and the second end; and
interlocked tabs and notches for secure assembly.

7. The device of claim 6, wherein the optical fiber strain relief features comprise:
a fiber jacketing gripping member in communication with the first end of the elongated member; and
a plurality of fiber jacketing gripping ridges defined in a gripping region adjacent to the second end of the elongated member;
wherein the optical fiber strain relief features provide strain relief and restrain lateral movement of the optical fiber.

8. The device of claim 1, further comprising overmolding surrounding an assembled device comprising the first half piece mated with the second half piece around an optical fiber splice.

9. The device of claim 8, wherein the overmolding is in communication with a portion of optical fiber extending from both ends of the splice.

10. The device of claim 8, wherein the half pieces include overmold windows allowing overmold material to enter and secure the optical fiber splice within the assembled device.

11. The device of claim 8, further comprising strain relief rings placed around each end of the device before applying an overmold material.

12. An overmolded optical fiber splice protective device comprising:
a first half piece and a second half piece, each comprising:
an elongated member, comprising:
a first end;
a middle section comprising a partial splice holder;
a first channel extending from the first end of the elongated member to the middle section and in communication with a first end of the partial splice holder;
a second end; and
a second channel extending from the second end of the elongated member to the middle section and in communication with a second end of the partial splice holder;
wherein the first half piece is configured to mate with the second half piece to form an assembled device; and
an overmold surrounding the assembled device.

13. The device of claim 12, wherein the first half piece is rotationally asymmetrical such that when rotated 180 degrees about a perpendicular axis and mated with a second half piece forms the assembled device, comprising:
a splice holder configured secure an optical fiber splice disposed in the middle section;
cylindrical channels for protecting optical fiber on either side of the middle section;
optical fiber strain relief features adjacent to the first end and the second end; and
interlocked tabs and notches for secure assembly.

14. The device of claim 12, further comprising a fiber jacketing gripping member in communication with the first end of the elongated member.

15. The device of claim 12, further comprising fiber jacketing gripping features defined in a gripping region adjacent to the second end of the elongated member.

16. The device of claim 15, wherein the gripping region is defined on an interior wall of the second channel.

17. A method of assembling an optical fiber splice protective device, comprising:
placing an optical fiber splice in a partial splice holder of a first half piece;
mating a rotated second half piece with the first half piece to form an assembled device such that a partial splice holder of a second half piece aligns with the partial splice holder of the first half piece to secure the optical fiber splice therebetween; and
applying an overmold material to encase the assembled device.

18. The method of claim 17, further comprising placing strain relief rings around ends of the device before applying the overmold.

19. The method of claim 17, wherein the first half piece and the second half piece comprise a plurality of tabs and notches; and
mating corresponding tabs and notches of the first half piece with notches and tabs of the second half piece.

20. The method of claim 17, wherein the first half piece and the second half piece each comprise:
a fiber jacketing gripping member in communication with a first end; and
a plurality of fiber jacketing gripping ridges defined in a gripping region adjacent to a second end; and
mating the first half piece to the second half piece so that the fiber jacketing gripping member and the plurality of fiber jacketing gripping ridges restrain jacketed optical fiber a the first end and the second end.
